(19) United States
(12) Patent Application Publication
(10) Pub. No.: US 2022/0188848 A1
(43) Pub. Date: Jun. 16, 2022

(54) SYSTEMS AND METHODS FOR SEGMENTING CONSUMER POPULATIONS BASED ON BEHAVIOR MOTIVATION DATA

(71) Applicant: CultureWaves, LLC, Ozark, MO (US)

(72) Inventors: Robert Byron Noble, Springfield, MO (US); Locke Hildebrand, Springfield, MO (US); David Nehmer, Springfield, MO (US); Kay Logsdon, Springfield, MO (US); Guy Colby Mace, Springfield, MO (US); Damien McDunn, Springfield, MO (US); Sterling Huff, Springfield, MO (US); William Alan Seagrave, Springfield, MO (US)

(21) Appl. No.: 17/550,554

(22) Filed: Dec. 14, 2021

Related U.S. Application Data
(60) Provisional application No. 63/205,457, filed on Dec. 14, 2020.

(51) Int. Cl. G06Q 30/02

(52) U.S. Cl. CPC G06Q 30/0204

(57) ABSTRACT

Systems and methods for segmenting consumer populations based on behavior motivation data are disclosed. In one embodiment, a method comprises identifying a population of electronic devices, selecting a first electronic device of the population of electronic devices, receiving a set of digital points of interest associated with the first electronic device, determining a dominant persona of a user of the first electronic device based on analyzing each digital points of interest in the set of digital points of interest, and generating a marketing report providing marketing recommendations or strategies for marketing to the user of the first electronic device based on data associated with the dominant persona.

### CROSS-REFERENCE TO RELATED APPLICATIONS

This application claims priority to U.S. Application No. 63/205,457 filed Dec. 14, 2020 and titled “Systems and methods for categorization of digital points of interest (applications, websites, blogs, etc.) by behavior motivation intent markers.” U.S. Application No. 63/205,457 is hereby fully incorporated by reference as if set forth fully herein.

### FIELD

The present invention relates generally to data analysis. More particularly, the present invention relates to systems and methods for segmenting consumer populations based on behavior motivation data.

### BACKGROUND

Known systems and methods that segment consumer populations for research and tactical purposes, such as, for example, marketing, recruitment, targeted advertising, product development, services development, risk assessment, and the like, are based primarily on demographic information, such as, for example, gender, age, income, education, ethnicity, hobbies, and the like. In other words, conventional consumer marketing primarily considered demographic information about target customers and used demographic-based methods for modeling customer behavior. However, demographic-based marketing makes large assumptions about members of each demographic, which are frequently inaccurate and often flat-out false. For example, not all men aged 50+ enjoy baseball, even though some demographic models may suggest that a significantly large number of men aged 50+ do. Even so, advertisers and merchants were satisfied to use generalities or even stereotypes of each segmented demographic populations because no better way of segmenting a consumer population was known. These demographic-based marketing programs and models fail to accurately capture affinities and interests of large swaths of the demographic population, thereby wasting marketing efforts on huge portions of a population lacking any interest in a given product or service.

Even with access to such other information about consumer populations, known systems and methods have been unable to gain additional insight by using that information. In particular, after segmenting consumer populations based on demographic information, known systems and methods have been unable to gather meaningful insights about consumer populations.

Furthermore, most, if not all, companies purchase the same demographic-based information, meaning that no companies obtain a competitive advantage in marketing by purchasing this widely available demographic information. Thus, purchasing the demographic information only “levels the playing field” but provides no real advantage because no entity has analyzed demographic data in an advantageous manner. Still, detailed analysis of the demographic information provides little new insight into customer behavior or improved marketing efforts targeted at interested customers.

In view of the above, there is a continuing, ongoing need for improved systems and methods that more accurately segment populations than conventional, demographics-based population segmentation methods.

### BRIEF DESCRIPTION OF THE DRAWINGS

FIG. 1 is a system diagram, according to an exemplary embodiment;

FIG. 2 is a flow chart describing the various steps implemented by the system of FIG. 1, according to an exemplary embodiment; and

FIGS. 3 and 4 show an exemplary marketing report generated by the system of FIG. 1 implementing the method of FIG. 2, according to an exemplary embodiment.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods for segmenting consumer populations based on behavior motivation data. In particular, the behavior motivation data can link a consumer behavior instance to an intent or a motivation, thereby driving an ability to understand the consumer behavior instance and/or identify an engagement route with a messaging strategy for an associated consumer, such as, for example, intervention with a high degree of behavior impact potential, intervention aligned or adjusted to product and service goals, and the like. As such, systems and methods disclosed herein can segment consumer populations based on intent and motivation categories of consumer behavior instances.

In accordance with disclosed embodiments, the consumer behavior instance can be identified by a digital point of interest (DPOI), product, or service that the associated consumer accesses, uses, or merely has installed on an associated device. In some embodiments, the DPOI can be an application installed on the associated customer's mobile device (e.g. tablet, smartphone, laptop, smart video devices, smart TVs, gaming system, vehicle digital DPOI systems, virtual reality systems, smart wearables, and any other smart device etc.), but DPOIs are not limited to installed applications and may include websites frequently accessed by the associated customer, blogs read or subscribed to by the associated customer, newsletters or digital catalogues subscribed to by the associated customer, social media posts or pages liked by the associated customer, or any other digital point of engagement accessed by the associated customer. Each DPOI can be associated with one or more sources of interest or behavior intent signals. Accordingly, systems and methods disclosed herein can link a source of interest of the DPOIs to a user identity by analyzing a set of DPOIs of the associated customer. Furthermore, responsive to the linking of DPOIs to the source of interest of the associated consumer and the behavior intent signal, the systems and methods disclosed herein can identify sets of consumer populations with common intents or motivations and, in some embodiments, identify messaging or an intervention strategy for effectively communicating and engaging with individuals in the sets of consumer populations identified.

In this way, the systems and methods disclosed herein can more accurately classify or categorize a person into an accurate identity based on motivations and behaviors, rather than demographics. Demographics can also be analyzed subsequently to help classify associated customers. Once properly classified, the system and methods can generate recommended merchandise or services to market to the associated customer as well as recommended marketing messaging to persuade the customer to purchase the recommended merchandise, services, or influence opinions and positions.

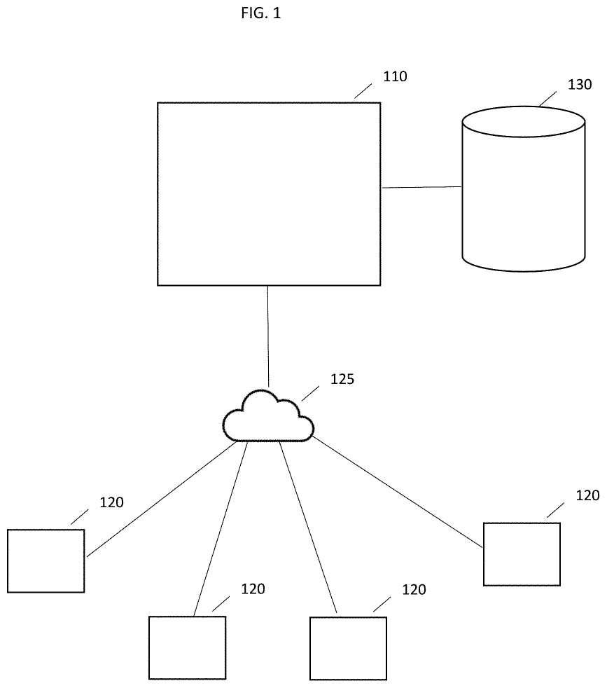

FIG. 1 illustrates an overall system diagram for categorizing and segmenting customers into behavior-based categories. The system 100 can include one or more servers 110 configured to provide the functionalities discussed herein. The specific methods and processes can be written in software that can be executed by one or more processors and memory of each of the one or more servers 110.

As shown in FIG. 1, the system 100 can include one or more users with electronic devices 120. Each electronic device 120 can each be associated with a respective user. In some embodiments, the electronic devices 120 can include mobile phones, but other electronic devices are envisioned including but not limited to tablets, computers, smart video devices, smart TVs, gaming systems, vehicle digital DPOI systems, virtual reality systems, smart wearables, and any other smart devices. The one or more servers 110 can connect to the electronic devices 120 via one or more networks 125, such as telephone networks, wide area networks, local area networks, the cloud, etc. In other embodiments, the one or more networks 125 can include the internet or a combination of internet and other networks. Likewise, other suitable telecommunication channels can also be used depending on the embodiments.

Each electronic device 120 includes at least a processor and memory. The memory of each electronic device 120 can include a stored set of DPOIs associated with each electronic device 120. For example, the stored set of DPOIs can include all the mobile applications stored on a mobile phone, such as an iPhone. In another embodiment, the stored set of DPOIs can include a history of all websites visited recently using the electronic device 120. Although these two DPOI examples are given, other stored DPOI sets are contemplated, such as “Liked” or “Followed” pages of a user's social media account, a user's set of digital subscriptions, or any other DPOI.

The one or more servers 110 can communicate with the electronic devices 120 and receive various information from each electronic device, including but not limited to, location data, identification data, and the set of DPOIs stored in the memory of each electronic device 120. The one or more servers 110 can also communicate information to the electronic devices 120 including targeting advertising material or other DPOIs relevant to a user.

The one or more servers 110 can further communicate with one or more databases 130. In some embodiments, the one or more servers 110 communicate with the one or more databases 130 via the network 125, but the one or more servers 110 can communicate more directly with the databases 130 over a bus or any other electrical connection. The one or more databases 130 can include classification systems that categorize a plurality of known DPOIs into various categories. The one or more servers 110 can use the data in the one or more databases 130 to classify each DPOI on each connected electronic device 120. Once classified, the one or more servers 110 can analyze the classification data to generate a consumer behavior instance for a user of each connected electronic device 120. In addition, the one or more databases 130 can store known data about each consumer behavior instance, such as preferred messaging, known attributes of people in each consumer behavior instance, and effective marketing messages to the people in each consumer behavior instances.

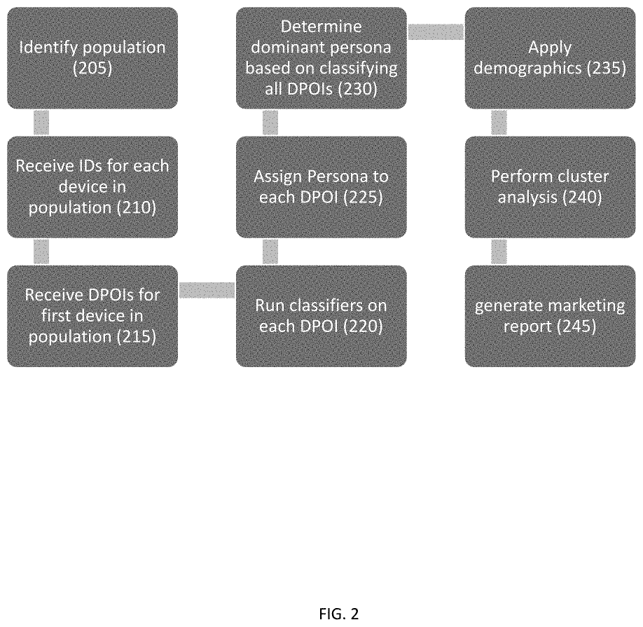

FIG. 2 is a flow chart of a method 200 in accordance with disclosed embodiments. As seen in FIG. 2, the method 200 can include identifying a population of relevant devices as in 205, identifying unique identification codes (i.e. “device ID”) of each relevant device in the population of relevant devices as in 210, and identifying digital points of interests accessed, used by, or associated with each relevant device in the population of relevant devices as in 215. As used herein, it is to be understood that the relevant devices can include, for example, portable user devices, computers, mobile phones, tablets, televisions, video game systems, vehicle systems, virtual reality systems, wearable devices, and the like, and the unique identification codes can include any numbers that uniquely identify each relevant device, such as, for example, phone numbers, serial numbers, network addresses, and the like.

In step 205, the one or more servers 110 of FIG. 1 can identify the population of relevant devices by selecting all the electronic devices 120 or a subset of the electronic devices 120. Step 205 can include setting some criteria for identifying the population of relevant devices. In some embodiments, the one or more servers 110 can use geographical information to identify the population of relevant devices. For example, the one or more servers 110 can set the criteria by creating a geofence and identify all of the electronic devices 120 within the geofence or within the geofence within some past period of time. The geofence can be a large geographic area (i.e. geographic coordinates associated with an entire city or state) or a small geographic area (e.g. geographic coordinates associated with a hotel or business). The geographic information can be real-time or past location data or both. Other means for generating a subset of the electronic devices 120 and setting the criteria are also envisioned, such as all electronic devices subscribed to a particular cellular network, all tablet devices connected to the one or more servers 110, all users of a social network, or all devices sold by a particular manufacturer or entity, all users having a predetermined job title or certification as set in a profile of a social network, etc. While some example methods for identifying a population have been described for illustration purposes only, all population segmentation methods are contemplated and the disclosed systems and methods can identify a population of devices according to any method that determines a set of devices. In addition, the geofence could include multiple, separate geographical locations.

In a mobile phone embodiment, installed applications continuously or frequently ping latitude and longitude data to consolidation warehouses that connect to and monitor a stream of location data pinging from mobile phones. The mobile phones ping data in this manner to notify potential advertisers that there is space within the app for an advertisement. In the matter of milliseconds, advertising transactions occur where advertisers will purchase the available ad space within a phone's installed application, and the application will display the ad content. Those having skill in the art will know that these microtransactions are a common method for digital advertising on mobile phones. The one or more servers 110 described herein can tap into this stream of location data to find electronic devices 120 within the targeted population 205 and generate the population of relevant devices. Alternatively, this location data stream gets stored in consolidation warehouse databases, and the location data can be accessed by the one or more servers 110 from the consolidation warehouse databases.

In an alternative embodiment, where DPOIs relate to social media activity, the population of relevant devices may not be geographical but a subset of users of the social media platform. For example, the one or more servers 110 could access the social media network, through an API or the like, and receive all users within a demographic or all users born in a predetermined geographical location. If the social media platform tracks user location, real-time user location can also be used, similar to the geofencing embodiment described above.

In step 210, the one or more servers 110 can receive unique identification codes from all the electronic devices 120 in the population of relevant devices by communicating with all electronic devices 120 in the population of relevant devices. The electronic devices 120 in the population of relevant devices can transmit any unique identification code to the one or more servers so that the one or more servers can associate unique information with each electronic device 120 in the population of relevant devices. In some embodiments, the unique identification codes are transmitted as part of the advertising transactions involving consolidation warehouses described above. The unique identification code can be any information that uniquely identifies an electronic device 120, such as a phone number associated with a mobile phone, a device serial number, an IMEI number, a MAC address, an IP address, an advertising identifier, or any other identification information that uniquely identifies each electronic device 120 in the population or relevant devices.

In step 215, the one or more servers 110 request and receive DPOIs from each electronic device 120 in the population of relevant devices. For example, the one or more servers 110 can request all the applications installed on each electronic device 120 in the population of relevant devices. In another embodiment, the one or more servers 110 can request Internet browsing history from each electronic device 120 in the population of relevant devices. While other DPOIs are contemplated, for the purposes of example only herein, the method 200 will be described assuming the DPOI collected by the one or more servers 110 are the installed applications on a mobile device.

As seen in FIG. 2, the method 200 can include classifying each DPOI using a plurality of classification criteria to assign at least one consumer behavior instance for each DPOI in step 220. Each DPOI may be assigned at least one and sometimes several consumer behavior instances, depending on the DPOI. The classification criteria used to evaluate each DPOI can include a motivational architecture classifier, a primary function classifier, a life category classifier, a general consumer category classifier, an engagement style classifier, a core need classifier, and a macro trend classifier. The one or more servers 110 can evaluate each DPOI using one, some, or all of the above-listed classifiers. The above-described classifiers will now be described each in detail.

The motivational architecture classifier can include previously aggregated motivational architectures, such as Maslow's Hierarchy of Needs, to align each DPOI with one of the entries in Maslow's Hierarchy of Needs. Maslow's Hierarchy of Needs can include but may not be limited to Physiological, Safety, Belonging, Esteem, and Self Actualization. The primary function of each DPOI can be evaluated, either by a team of human beings or by the one or more servers 110, to determine where this primary function fits in the Maslow's Hierarchy of Needs. For example, a shopping application may be used for product identification and discovery, price comparison, product specification research, speed to buy, speed to receive, product consumer evaluations, and other markers. Alternatively, a grocery shopping application may be determined to fit within the “Physiological” category because groceries are a physiological need. If a human being associates a DPOI with a structural component of Maslow's Hierarchy of Needs, this determination can be saved in the database 130, and the one or more servers 110 can use the data in the database 130 to classify the DPOI using this classifier. For example, if a human previously determined that the Google Photos mobile application belongs in the Esteem category, the one or more servers 110 can access that determination in the database 130 and continue the method 200 using this determination. While Maslow's Hierarchy of Needs is discussed for example purposes only, other psychological or phsycographic systems are also contemplated besides Maslow's Hierarchy of Needs for use in determining a DPOI's primary function.

The primary function classifier can recognize each DPOI's primary function, which can include but are not limited to shopping, entertainment, finding directions with a map, news reading, and others. The primary function of each DPOI can be evaluated, either by a team of human beings or by the one or more servers 110, to determine each application's primary function. For example, the Amazon application can be categorized as a shopping application because it is primarily used to purchase items. While the Amazon application might have other uses and functions, only the primary function of the application is determined. If a human being associates a DPOI with a primary function, this determination can be saved in the database 130, and the one or more servers 110 can use the data in the database 130 to classify the DPOI using this classifier. For example, if a human previously determined that the Amazon mobile application belongs in the shopping category, the one or more servers 110 can access that determination in the database 130 and continue the method 200 using this determination.

The life categories classifier can compare each DPOI's primary function to a predetermined set of categories, including but not limited to design, technology, entertainment, and wellbeing. The life categories can mark consumer interest categories. The life category of each DPOI can be evaluated, either by a team of human beings or by the one or more servers 110. For example, the Amazon Video application can be categorized as an entertainment application because it is primarily used to watch video content. If a human being associates a DPOI with a life category, this determination can be saved in the database 130, and the one or more servers 110 can use the data in the database 130 to classify the DPOI using this classifier. For example, if a human previously determined that the Amazon Video mobile application belongs in the entertainment life category, the one or more servers 110 can access that determination in the database 130 and continue the method 200 using this determination.

The general consumer categories classifier can evaluate each DPOI's core business surrounding each DPOI, including but not limited to entertainment, health, food, and others. The general consumer category of each DPOI can be evaluated, either by a team of human beings or by the one or more servers 110. For example, the Noom application can be categorized as a health application because it is primarily used to help users lose weight. If a human being associates a DPOI with a general consumer category, this determination can be saved in the database 130, and the one or more servers 110 can use the data in the database 130 to classify the DPOI using this classifier. For example, if a human previously determined that the Noom mobile application belongs in the heath general consumer category, the one or more servers 110 can access that determination in the database 130 and continue the method 200 using this determination.

The engagement style categories classifier can evaluate how each DPOI engages with the outside world, styles that include but are not limited to curated styles, aggregated styles, and contributed engagement. The engagement style category of each DPOI can be evaluated, either by a team of human beings or by the one or more servers 110. For example, the Reddit application can be categorized as aggregated because all the posts are user created. If a human being associates a DPOI with an engagement style category, this determination can be saved in the database 130, and the one or more servers 110 can use the data in the database 130 to classify the DPOI using this classifier. For example, if a human previously determined that the Reddit mobile application belongs in the aggregated style, the one or more servers 110 can access that determination in the database 130 and continue the method 200 using this determination.

The core need categories classifier can evaluate user intent for using each DPOI, needs that include but are not limited to connection, immediacy, downtime, trust, and more. The core need category of each DPOI can be evaluated, either by a team of human beings or by the one or more servers 110. For example, a mobile game application can be categorized as “downtime” because mobile games are typically played during downtime or to pass time. If a human being associates a DPOI with a core need category, this determination can be saved in the database 130, and the one or more servers 110 can use the data in the database 130 to classify the DPOI using this classifier. For example, if a human previously determined that a mobile gaming application belongs in the downtime category, the one or more servers 110 can access that determination in the database 130 and continue the method 200 using this determination. In some embodiments, this classifier can generate a needs-based persona variable, which can be used to determine the persona of a user associated with the selected electronic device 120.

The macro trend classifier can include previously aggregated motivational architectures, such as Maslow's Hierarchy of Needs, to align each DPOI with one of the in Maslow's Hierarchy of Needs. Within the major category of Maslow's Hierarchy (e.g. Physiological, Safety, Belonging, Esteem, and Self Actualization), one or more behavioral drivers can be defined (e.g. connection, urgency, value, loyalty, etc.). The macro wave classifier identifies the driving factor why a person would engage with an application from within the list of behavioral drivers. Each DPOI can be evaluated, either by a team of human beings or by the one or more servers 110, to determine what influences a person to download and use any given DPOI. If a human being associates a DPOI with a behavioral driver of Maslow's Hierarchy of Needs, this determination can be saved in the database 130, and the one or more servers 110 can use the data in the database 130 to classify the DPOI using this classifier. For example, if a human previously determined that the Discord mobile application belongs in the “connection” behavioral driver, the one or more servers 110 can access that determination in the database 130 and continue the method 200 using this determination. In some embodiments, this classifier can generate a behavior intent-based persona variable, which can be used to determine the persona of a user associated with the selected electronic device 120. In another embodiment, some or all of the above-described classifiers can generate the behavior intent-based persona variable.

Not all DPOIs provide valuable information, and some DPOIs are so ubiquitous that they do not differentiate one persona from another persona. For example, many if not most mobile devices include the Facebook mobile application. People of all types of personas use Facebook, so this application may not differentiate one person from another. The same can be said of some “core” applications, such as an email application or a phone application. The one or more servers 110 can ignore some DPOIs or remove them from subsequent evaluations.

After evaluating one or more of the above-described classifiers, the one or more servers 110 can gather all the classifications and assign at least one persona to each analyzed DPOI. The at least one persona may be determined using the intent-based persona variable, the needs-based persona variable, and/or a scoring system that combines all the above-described classifiers. Collectively, all the variables can be considered intent indicators, and each DPOI may include multiple intent indicators. Each DPOI can be evaluated, either by a team of human beings or by the one or more servers 110, to determine a persona or multiple personas for each DPOI. For example, if a human previously determined that the Discord mobile application belongs in a first persona, the one or more servers 110 can access that determination in the database 130 and continue the method 200 using this determination. Alternatively, the Twitter mobile application may be assigned multiple personas based on multiple intent indicators associated with the Twitter mobile application.

After running one, some, or all of the above-described classifiers, a DPOI is assigned at least one persona in step 225. The process of filtering, categorizing, and assigning at least one persona repeats for every DPOI on a selected electronic device. In some embodiments, the one or more servers 110 may further evaluate the amount of time or interactions a user has with each DPOI. If the one or more servers 110 consider DPOI interaction time, DPOIs having higher interaction time can be weighted more heavily in subsequent determinations that ultimately assign a persona to a user of the selected electronic device 120. The weight can be based on the amount of interaction time with the DPOI or how many times the DOPI is accessed over a defined period of time.

Regardless, the one or more servers 110 can aggregate all the categorized DPOIs to determine a dominant persona category or the most common DPOI persona on the selected electronic device 120 in step 230. The one or more servers 110 can analyze all the determined personas for all the DPOIs on the selected electronic device 120 and find the most common or most prevalent persona among the determined DPOI personas. For example, if the selected electronic device 120 includes numerous community DPOIs or numerous DPOIs having a behavior intent based personal variable indicating community (e.g. Snapchat, YOLO: Anonymous Q&A, Discord, TikTok, Zoom), then the selected electronic device 120 can be assigned the persona “the connected” or the persona most associated with community intents and motivations. Numerous personas are envisioned, such as “the immediate” (i.e. users driven by convenience as indicated by applications such as Pandora Music, Tubi TV, Deezer, and Google Photos), “the careful” (i.e. users driven by the need for preparation and those who avoid surprises, as indicated by applications such as CNBC, Yahoo Weather, and Speedtest by Ookla), “the connected” (i.e. those looking for and participating in communities both online and offline, as indicated by applications like Snapchat, Discord, and Tiktok), “the adaptive” (i.e. those looking for accessibility and blurring the line between the real and virtual worlds, as indicated by applications like TextNow, Dropbox, Amazon Alexa, and Smiles), and many other personas. While a few exemplary personas are described above, the disclosed systems and methods can cover any persona or personality classifier. Indeed, numerous personas are envisioned, not just those provided herein for illustration purposes only.

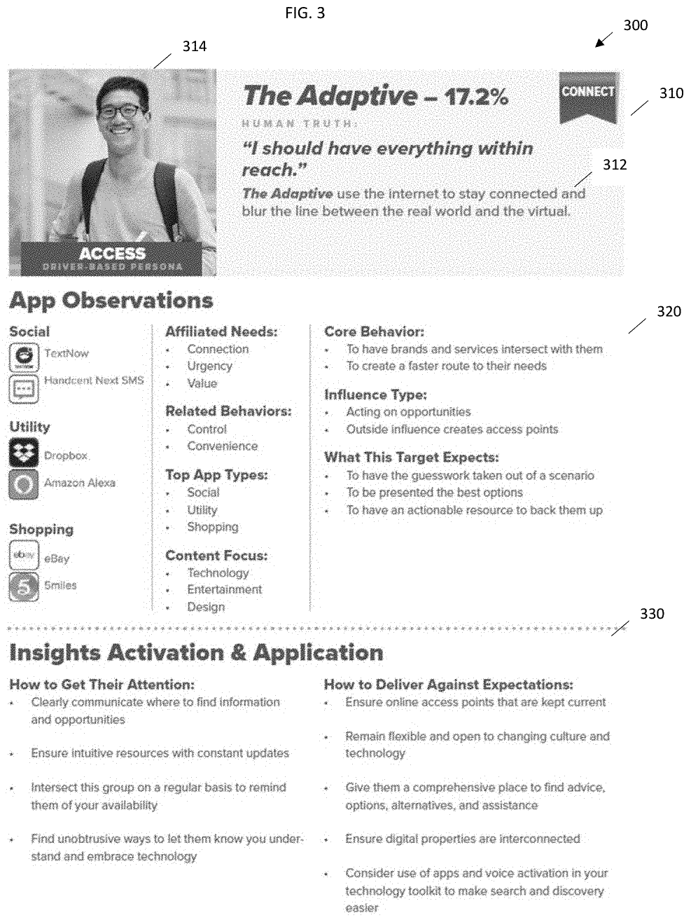

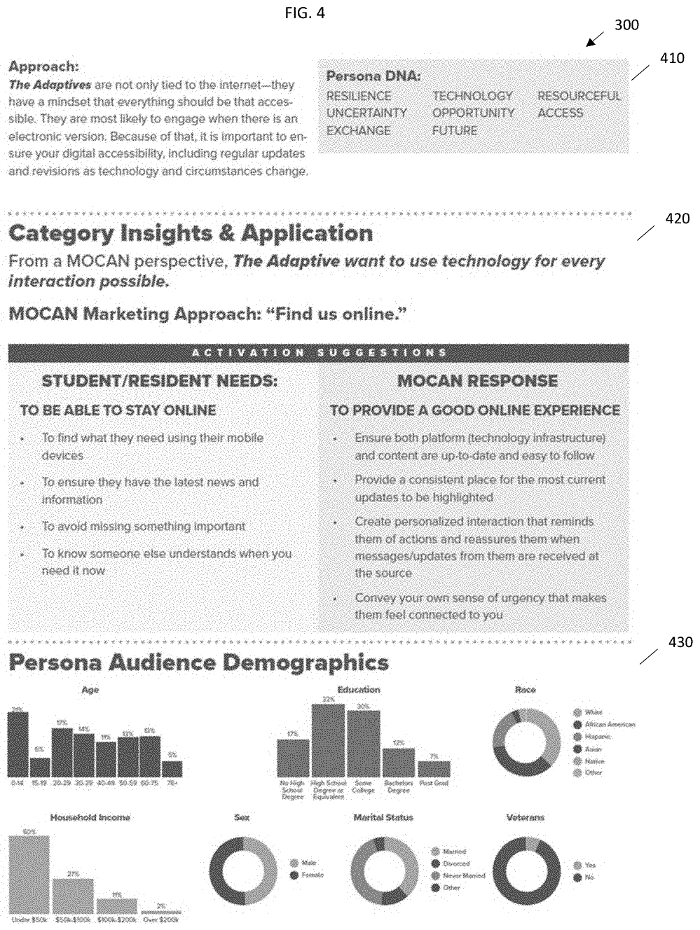

The personas described above can be predetermined. Behavioral economics and long-term studies of human behavior can define or help to define the personas. The personas can include a data structure that stores attributes about people falling into each persona. The persona data structure can store DPOI observations, such as affiliated needs, related behaviors, influence type, core behaviors, what each persona expects, and content focus. The persona data structure can further include insights about people falling into this persona, such as how to get their attention and how to deliver against expectations. Additionally, the persona data structure can include a marketing approach. In this way, the persona data structure can include marketing recommendations to help merchants and service providers effectively market products and services to potential customers. These elements of the persona data structure are described in greater detail with regard to FIGS. 3 and 4.

The one or more servers 110 can further apply demographics information to each persona in the population of electronic devices in step 235. In some embodiments, the one or more servers 110 can receive demographics information from one or more of the DPOIs, which may store demographic information as part of an opt-in process or a sign-up process. Alternatively or additionally, the one or more servers 110 can receive some demographic information from data stored in the memory of the selected electronic device 120. The demographic information is optional and can provide additional information about the behavioral segmentation of the population by personas.

Subsequent to determining and assigning a dominant persona to each electronic device 120 in the population of electronic devices 120, the one or more servers 110 can perform a cluster analysis to determine what percentage of the population of electronic devices 120 falls into each persona (i.e. behavioral segmentation) in step 240. Furthermore, the one or more servers 110 can generate marketing recommendations and suggested messaging for each persona in step 245. The marketing recommendations can come in the form of a marketing report, which is described in more detail with regard to FIGS. 3 and 4.

The cluster analysis in step 240 can provide additional insights into the population of electronic devices 120. The cluster analysis can indicate the most common persona(s) in the population of electronic devices. Depending on which persona is found to be most common in the population of electronic devices 120, the marketing recommendations 245 may change. For example, if the dominate persona is “the immediate”, the marketing recommendations may suggest that marketing efforts focus on messaging that can resonate with this persona, while suggesting that the client forego messaging that may resonate with uncommon personas in the population of devices. In this way, marketing recommendations not only provide messaging that can resonate with each persona but also the marketing recommendations can provide suggestions for messaging and marketing that will target the largest audience. Additionally or alternatively, the marketing recommendations can provide a list of electronic devices that fall within a target persona. For example, a recreational equipment retailer may want to target the persona “the explorer” or “the enthusiast” because this persona is most likely to want outdoor gear for adventurous activities. So, even if the most common persona in a population of electronic devices 120 is “the immediate”, the recreational equipment retailer may only want to target marketing to users and electronic devices 120 having the persona “the explorer” or “the enthusiast” because these personas are most likely to frequent or patronize the recreational equipment retailer. In this way, the marketing recommendations 245 can be tailored to a client. The one or more servers 110 can provide the users or devices in a targeted persona using the collected unique identification codes in step 210.

Referring to FIG. 3, FIG. 3 illustrates an exemplary persona marketing report 300 generated by the one or more servers 110 in step 245 of method 200. As shown, the marketing report 300 can include a description of the persona 310, app observations about the persona 320, and insights about the persona 330. While the exemplary persona shown in FIGS. 3-4 show for illustration purposes “The Adaptive” persona, the one or more servers 110 can generate a persona marketing report 300 for every persona data structure in the database 130.

As shown in FIG. 3, the description of the persona 310 can include a brief description of the persona 310, here describing “The Adaptive” as people who use the internet to stay connected and blur the line between the real world and the virtual. In some embodiments, the description 312 of the persona 310 can include a picture 314 of a user who has the persona.

The app observations 320 can include a list of typical applications found on a device of a user having this persona, affiliated needs, related behaviors, top app types, content focus, core behavior, influence type, what this target persona expects, etc. The app observations can be stored in the persona data structure. In some embodiments, these elements can change from population-to-population based on changes in the analyzed data. In another embodiment, these elements remain static because they apply to all people classified as having this persona.

The insights about the persona 330 can include suggestions for getting this persona's attention and how to deliver to this persona against expectations. The insights 330 can be stored in the persona data structure. In some embodiments, these elements can change from population-to-population based on changes in the analyzed data. In another embodiment, these elements remain static because they apply to all people classified as having this persona.

Referring to FIG. 4, FIG. 4 further illustrates the exemplary persona marketing report 300 generated by the one or more servers 110 in step 245 of method 200. As shown, the persona marketing report 300 can also include an approach 410, marketing suggestions 420, and audience demographics 430.

As shown in FIG. 4, the approach 410 can include a brief description explaining how to best approach the persona with marketing information. In some embodiments, the approach 410 can include a persona DNA section listing typical descriptions of people having this persona.

The marketing suggestions 420 can include a list of the needs of people having this persona and good marketing responses to those needs. This section can further include a Marketing approach that has been proven effective on this category of people.

Furthermore, the demographics section 430 can list the determined demographics of the people having this persona in the population. The listed demographics can include age, education, race, household income, sex, marital status, and veteran status, but additional demographics are contemplated.

The one or more servers 110 can generate a marketing report, like the marketing report 300 shown in FIGS. 3-4, for each of the personas identified in the population of electronic devices 120. In some embodiments, the one or more servers 110 can generate a marketing report only for the most common personas in the population of electronic devices 120. In addition to the content shown in FIGS. 3 and 4, the one or more servers can produce additional content in the generated marketing report depending on the results of the cluster analysis. For example, the one or more servers 110 can generate a different report when the most common persona in the population of electronic devices 120 is “the careful” than when the most common persona in the population of electronic devices 120 is “the adaptive” or another persona. In some embodiments, the marketing report 300 generated in step 245 can be tailored to the client or the product or service marketed. In some embodiments, a marketing team can add content to the marketing report to customize or personalize the marketing report for a client. Finally, the marketing report can include content explaining why the persona-based marketing method is or will be particularly effective over conventional, demographics-based marketing methods.

In view of the above, the systems and methods described herein offer a significant advancement over the prior art. The systems and methods described herein classify people according to motivational and behavioral aspects of their personality rather than demographics alone. The motivational and behavioral aspects capture a person's goals, intents, and characteristics far more accurately than demographics. As such, the marketing strategies generated by the systems and methods described herein are far more effective at generating marketing that will resonate with target audiences. In addition, the systems and methods described herein are better at identifying a target audience than conventional methods that simply sought large numbers of “eyeballs”.

In addition, the systems and methods described herein demonstrate an improvement to marketing technology over conventional systems. The systems and methods herein can classify people according to digital points of interests associated with each given person in a population, which is a far better indicator of a person's traits and characteristics than demographics alone. By analyzing digital points of interests on a user's personal electronic device, a far more accurate representation of the person can be gleaned by the systems and methods described herein. Furthermore, because the systems and methods described herein can classify a person more accurately using digital points of interests, the systems and methods can generate a marketing report that will be far more informative than conventional methods of generating marketing reports. Finally, because the system and methods described herein can generate a marketing report automatically, far less human interaction and analysis is required by marketing teams in generating marketing strategies for clients.

Although a few embodiments have been described in detail above, other modifications are possible. For example, other components may be added to or removed from the described systems, and other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A method comprising:
identifying a population of electronic devices;
receiving a set of digital points of interest associated with a first electronic device;
determining, for each digital point of interest in the set of digital points of interest, at least one behavioral intent indicator associated with each digital point of interest in the set of digital points of interest, wherein each behavioral intent indicator is data indicating a motivational or behavior-based classifier explaining why a person would access a selected digital point of interest;
assigning, for each digital point of interest in the set of digital points of interest, at least one persona based on the at least one behavioral intent indicator;
determining a dominant persona of a user of the first electronic device based on aggregating and analyzing the personas assigned to each digital point of interest in the set of digital points of interest; and
generating a marketing report providing marketing recommendations or strategies for marketing to the user of the first electronic device based on data associated with the dominant persona.

2. The method of claim 1 wherein identifying the population of electronic devices comprises defining a geofence around a geographical area and determining which electronic devices are within or were within the geofence.

3. The method of claim 2 wherein determining which electronic devices are within or were within the geofence comprises receiving location data for a plurality of electronic devices from a consolidation warehouse and determining whether the location data for each electronic device in the plurality of electronic devices corresponds to or falls within the geofence.

4. The method of claim 1 further comprising:
receiving identification data for each electronic device in the population of electronic devices.

5. The method of claim 4 further comprising:
transmitting the identification data for all electronic devices in the population of electronic devices having a first persona to a client.

6. The method of claim 1 wherein the set of digital points of interest associated with the first electronic device comprises mobile applications installed on the first electronic device.

7. The method of claim 1 wherein the set of digital points of interest associated with the first electronic device comprises internet browsing history stored on a memory of the first electronic device.

8. The method of claim 1 wherein determining the at least one behavioral intent indicator associated with each digital point of interest in the set of digital points of interest comprises applying one or more classifiers to each digital point of interest in the set of digital points of interest to determine the at least one behavioral intent indicator associated with each digital point of interest in the set of digital points of interest.

9. The method of claim 8 wherein the one or more classifiers comprise a motivational architecture classifier, a primary function classifier, a life category classifier, a general consumer category classifier, an engagement style classifier, a core need classifier, and a macro trend classifier.

10. The method of claim 1 further comprising determining demographics information of each persona in the population of electronic devices, wherein the marketing report includes the demographics information.

11. The method of claim 1 wherein each persona is associated with a persona data structure, and wherein each persona data structure comprises data representing insights about people falling into the persona and a marketing approach with recommendations to help merchants or service providers effectively market products and services to potential customers having the persona.

12. The method of claim 1 further comprising performing a cluster analysis after the dominant persona is determined for each electronic device in the population of electronic devices to determine a percentage of electronic devices falling into every persona.

13. The method of claim 1, further comprising receiving a second set of digital points of interest associated with a second electronic device;
determining, for each digital point of interest in the second set of digital points of interest, at least one behavioral intent indicator associated with each digital point of interest in the second set of digital points of interest;
assigning, for each digital point of interest in the second set of digital points of interest, at least one persona based on the at least one behavioral intent indicator;
determining a second dominant persona of a second user of the second electronic device based on aggregating and analyzing the personas assigned to each digital point of interest in the second set of digital points of interest; and
generating a second marketing report providing marketing recommendations or strategies for marketing to the second user of the second electronic device based on data associated with the dominant persona

14. A system comprising:
a memory; and
a processor configured to (a) identify a population of electronic devices, (b) select a first electronic device of the population of electronic devices, (c) receive a set of digital points of interest associated with the first electronic device, (d) determine, for each digital point of interest in the set of digital points of interest, at least one behavioral intent indicator associated with each digital point of interest in the set of digital points of interest, (e) assign, for each digital point of interest in the set of digital points of interest, at least one persona based on the at least one behavioral intent indicator, (f) determine a dominant persona of a user of the first electronic device based on aggregating and analyzing the personas assigned to each digital points of interest in the set of digital points of interest, and (g) generate a marketing report providing marketing recommendations or strategies for marketing to the user of the first electronic device based on data associated with the dominant persona,
wherein each behavioral intent indicator is data indicating a motivational or behavior-based classifier explaining why a person would access a selected digital point of interest.

15. The system of claim 14 wherein the processor identifies the population of electronic devices by defining a geofence around a geographical area and determining which electronic devices are within or were within the geofence.

16. The system of claim 15 wherein the processor determines which electronic devices are within or were within the geofence by receiving location data for a plurality of electronic devices from a consolidation warehouse and determining whether the location data for each electronic device in the plurality of electronic devices corresponds to or falls within the geofence.

17. The system of claim 14 wherein the processor is further configured to:
receive identification data for each electronic device in the population of electronic devices.

18. The system of claim 17 wherein the processor is further configured to:
transmit the identification data for all electronic devices in the population of electronic devices having a first persona to a client.

19. The system of claim 14 wherein the set of digital points of interest associated with the first electronic device comprises mobile applications installed on the first electronic device.

20. The system of claim 14 wherein the set of digital points of interest associated with the first electronic device comprises internet browsing history stored on a memory of the first electronic device.

21. The system of claim 14 wherein the processor determines the at least one behavioral intent indicator associated with each digital point of interest in the set of digital points of interest by applying one or more classifiers to each digital point of interest in the set of digital points of interest to determine the at least one behavioral intent indicator associated with each digital point of interest in the set of digital points of interest.

22. The system of claim 21 wherein the one or more classifiers comprise a motivational architecture classifier, a primary function classifier, a life category classifier, a general consumer category classifier, an engagement style classifier, a core need classifier, and a macro trend classifier.

23. The system of claim 14 wherein the processor is further configured to determine demographics information of each persona in the population of electronic devices, wherein the marketing report includes the demographics information.

24. The system of claim 14 wherein each persona is associated with a persona data structure, and wherein each persona data structure comprises data representing insights about people falling into the persona and a marketing approach with recommendations to help merchants or service providers effectively market products and services to potential customers having the persona.

25. The system of claim 14 wherein the processor is further configured to perform a cluster analysis after the processor determines the dominant persona for each electronic device in the population of electronic devices to determine a percentage of electronic devices falling into every determined dominant persona.

26. The system of claim 14 wherein the processor is further configured to:
(h) receive a second set of digital points of interest associated with a second electronic device, (i) determine, for each digital point of interest in the second set of digital points of interest, at least one behavioral intent indicator associated with each digital point of interest in the second set of digital points of interest, (j) assign, for each digital point of interest in the second set of digital points of interest, at least one persona based on the at least one behavioral intent indicator, (f) determine a second dominant persona of a second user of the second electronic device based on aggregating and analyzing the personas assigned to each digital points of interest in the second set of digital points of interest, and (g) generate a marketing report providing marketing recommendations or strategies for marketing to the second user of the second electronic device based on data associated with the second dominant persona

27. A method comprising:
identifying a population of electronic devices;
selecting a first electronic device of the population of electronic devices;
receiving a set of digital points of interest associated with the first electronic device;
determining a dominant persona of a user of the first electronic device based on analyzing each digital points of interest in the set of digital points of interest; and
generating a marketing report providing marketing recommendations or strategies for marketing to the user of the first electronic device based on data associated with the dominant persona.
